(19) United States
(12) Patent Application Publication
(10) Pub. No.: US 2007/0251501 A1
(43) Pub. Date: Nov. 1, 2007

(54) Fuel supply apparatus of engine

(75) Inventors: Umerujan Sawut, Kanagawa-ken (JP); Masashi Iwasaki, Kanagawa-ken (JP); Shinya Yamaguchi, Kanagawa-ken (JP)

Correspondence Address: RADER FISHMAN & GRAUER PLLC, LION BUILDING, 1233 20TH STREET N.W., SUITE 501, WASHINGTON, DC, 20036, US

(73) Assignee: NIKKI CO., LTD., Atsugi-shi (JP)

(21) Appl. No.: 11/785,804

(22) Filed: Apr. 20, 2007

(30) Foreign Application Priority Data
Apr. 26, 2006 (JP) 2006-122156

(51) Int. Cl. F02M 59/36

(52) U.S. Cl. 123/458; 123/497

(57) ABSTRACT

In a fuel supply apparatus of a returnless type engine provided with fuel supply pipe lines (5, 6) extended from a fuel tank (2) and having an injector (8) in a leading end side, a fuel pump (3) having an electric motor (31) arranged in the fuel supply pipe line, and an electronic control unit (10) in which a fuel supply control program for controlling so as drive the electric motor (31) and the injector (8) is installed, a pressure sensor (11) detecting a fuel pressure so as to output to the electronic control unit (10) is arranged at a predetermined position of the fuel supply pipe line (6) in a downstream side of the fuel pump (3), and the electronic control unit (10) continuously calculates a minimum driving amount of the electric motor (31) necessary for maintaining a target fuel injection pressure on the basis of the fuel pressure value continuously detected by the electronic control unit (10) so as to command, thereby feedback controlling the operation of the fuel pump (3) and maintaining a fuel injection pressure approximately constant.

### BACKGROUND OF THE INVENTION

1. Field of the Invention

The present invention relates to a fuel supply apparatus feeding a fuel in a fuel tank to an injector so as to supply to an engine while controlling an operation of a fuel pump by an electronic control unit.

2. Description of Related Art

In recent years, in an automotive engine, there is increased a demand of an environmental correspondence such as an exhaust gas performance or the like, and a high mileage, in addition to a demand of a high torque and a high output. Particularly, since a fuel pump control has a high relevance to a control performance and a reliability of the engine, it is required to secure a high reliability as well as there is required a high speed, a high performance and an energy saving.

In a conventional engine fuel supply control, the structure is generally made such as to keep a constant pressure by a pressure regulator as well as driving a fuel pump by a drive motor so as to pressurize the fuel, and return a surplus component which is not injected from the injector in the delivered fuel to the fuel tank by a return piping through a pressure regulator or the like. In this case, in order to correspond to every engine operation condition, a discharge flow rate of the fuel pump is set to be equal to or more than a maximum amount of the fuel injected from the injector, thereby always operating the fuel pump at a constant high rotation.

However, under a condition that a fuel injection amount from the injector is zero or extremely small, for example, an idling time, a fuel cut time or the like, since most of the delivered fuel is returned to the fuel tank from the pressure regulator or the like, an energy (an electric power) applied to the fuel pump is unnecessarily consumed. Further, there is a case that a temperature of the fuel within the tank is increased due to the return of a lot of surplus fuel to the fuel tank. Particularly, in the case of using a fuel which is easily vaporized, an excess ascent of the fuel within the tank tends to present a problem. Further, in the case that the fuel pump is always operated at a high speed, there is generated a problem that a durability of the apparatus is lowered due to an abrasion.

With regard to this problem, as described in Japanese Unexamined Patent Publication No. 7-54725, there is considered a method of securing a reduction of an electric power consumption and a durability of a fuel pump, and reducing a surplus fuel returning to the fuel tank, by switching a pump discharge amount between two stages comprising a normal operation and a high zone. However, in accordance with such a course control, since it is impossible to accurately correspond to a fuel required flow rate which is finely or widely changed on the basis of an operating state of the engine, it is impossible to sufficiently reduce the surplus fuel, and it is not said that the reduction of waste of the electric power consumption is sufficient.

### SUMMARY OF THE INVENTION

The present invention is made for the purpose of solving the problem as mentioned above, and an object of the present invention is to provide a fuel supply apparatus delivering a fuel stored in a fuel tank to an injector by a fuel pump so as to supply to an engine, wherein an excellent durability is achieved as well as it is possible to minimize a waste of an energy by an operation of a fuel pump.

In order to solve the problem mentioned above, in accordance with the present invention, there is provided a fuel supply apparatus of a returnless type engine comprising:

a fuel supply pipe line extended from a fuel tank and having an injector in a leading end side;

an electric motor driven type fuel pump arranged in the fuel supply pipe line;

an electronic control unit in which a fuel supply control program for controlling so as drive the electric motor and the injector is installed; and

a fuel being pressurized by the fuel pump and fed to the injector through the fuel supply pipe line so as to be supplied to the engine,

wherein a pressure sensor detecting a fuel pressure so as to output to the electronic control unit is arranged at a predetermined position in a downstream side of the fuel pump of the fuel supply pipe line in which a fuel pressure approximately coincides with a fuel injection pressure, and the electronic control unit continuously calculates a minimum driving amount of the electric motor necessary for maintaining a target fuel injection pressure on the basis of the detected fuel pressure value so as to command, thereby feedback controlling the operation of the fuel pump and maintaining a fuel injection pressure approximately constant.

As mentioned above, since the returnless type fuel supply system is structured in such a manner that the delivered fuel is not returned to the fuel tank, and the electronic control unit is structured such as to feedback control precisely the operation of the fuel pump so as to maintain the predetermined fuel injection pressure while monitoring the fuel pressure in the downstream side of the fuel pump, it is possible to restrict the operating amount of the fuel pump to the minimum amount while restricting the fluctuation of the fuel injection pressure to the minimum, and it is possible to increase a durability while avoiding the consumption of the constituting parts of the fuel pump as well as reducing an energy consumption for driving the electric motor.

Further, the structure may be made such that the fuel supply control program installed in the electronic control unit is designed by utilizing a predetermined numerical expression model relating to the fuel pump control while taking a performance of the electric motor into consideration, and a predetermined numerical expression model taking into consideration a volumetric capacity of the fuel delivery pipe line in the downstream side of the fuel pump for calculating the pump discharge pressure in correspondence to a change of the fuel injection amount, whereby it is possible to employ a model base control method for the fuel supply control by the electronic control unit, it is possible to easily design and manufacture the fuel supply apparatus which achieves the precise control without actually executing the test, and it is possible to easily and properly control the pump rotating speed and the pump discharge flow rate for making the pump discharge pressure constant in a wide range.

In accordance with the present invention which achieves the returnless type fuel supply method maintaining the fuel injection pressure approximately constant by feedback controlling the operation of the electric motor by the electronic control unit on the basis of the detected fuel pressure value, it is possible to achieve an excellent durability while making the operating amount of the fuel pump minimum so as to avoid the waste of the energy.

### BRIEF DESCRIPTION OF THE DRAWINGS

FIG. 1 is a layout view showing an embodiment in accordance with the present invention;

FIG. 2A is a graph of a pump discharge pressure by a fuel supply apparatus in FIG. 1;

FIG. 2B is a graph of a load torque by the fuel supply apparatus in FIG. 1;

FIG. 3A is a graph of a pump discharge flow rate by the fuel supply apparatus in FIG. 1;

FIG. 3B is a graph of the fuel injection amount by the fuel supply apparatus in FIG. 1;

FIG. 4A is a wave form chart of an input voltage of an electric motor by the fuel supply apparatus in FIG. 1;

FIG. 4B is a graph of a cam angular velocity by the fuel supply apparatus in FIG. 1; and

FIG. 4C is a wave form chart of a motor current by the fuel supply apparatus in FIG. 1.

### DESCRIPTION OF PREFERRED EMBODIMENTS

A description will be in detail given below of a best mode for carrying out the present invention with reference to the accompanying drawings.

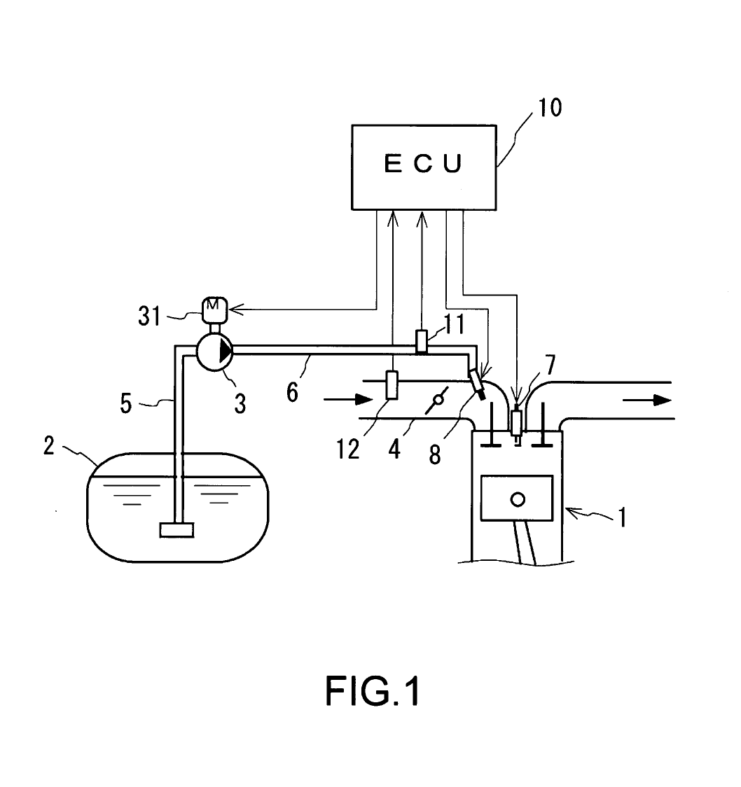

FIG. 1 shows a layout view of a fuel supply system for a gasoline engine in which a fuel supply apparatus in accordance with the present embodiment is arranged. There is structured a returnless type fuel supply system in which a fuel pump 3 having an electric motor 31 is arranged in a leading end side of a fuel supply pipe line 5 extended from a fuel tank 2, a leading end side of a fuel supply pipe line 6 extended from the fuel pump 3 is connected to an injector 8 arranged in an intake pipe line 4 of an engine 1, and a fuel return pipe line is not provided in a downstream side of the injector 8.

The fuel pump 3, the injector 8 and a spark plug 7 are electrically connected to an electronic control unit 10, and is structured such as to be controlled so as to be driven in correspondence to an operating state of the engine 1. Further, a pressure sensor 11 detecting a fuel pressure is arranged in a front side of the injector 8 of a fuel supply pipe line 6 corresponding to a downstream side of the fuel pump 3, and is structured such as to output a detection signal to the electronic control unit 10.

The electronic control unit 10 is structured such as to continuously monitor the detection signal of the pressure sensor 11, calculate a deviation between an actual fuel pressure just before the injector 8 which approximately coincides with a fuel injection pressure, and a previously defined target fuel injection pressure, and feedback control an operation of an electric motor 31 in such a manner that a pump discharge pressure coincides with a target fuel injection pressure, and is structured such as to control a pump discharge flow rate and a pump discharge pressure by controlling a motor rotational speed, thereby maintaining an approximately constant fuel injection pressure. This point corresponds to a first aspect of the present invention. In this case, the feedback control can be executed by storing and arranging a fuel supply control program for executing a predetermined procedure and calculating method utilizing a well-known control theory such as a PID control, a modern control theory or the like in a memory means of a general-purpose electronic control unit.

Further, the fuel supply apparatus in accordance with the present invention provided with the electronic control unit 10 as mentioned above has a second feature of the present invention in a point that the fuel supply apparatus is designed by using the model base control method by executing a simulation by using a numerical expression mentioned below.

$$\ddot{θ} = - \frac{1}{J} ( D + \frac{{N}^{2} {K}_{t} {K}_{e}}{{R}_{a}} ) \dot{θ} - \frac{1}{J} {K}_{s} θ + \frac{{NK}_{t}}{{R}_{a} J} {U}_{a} - \frac{1}{J} ( {d}_{k} sign ( \dot{θ} ) + {T}_{L} ) \qquad ( 1 )$$

The numerical expression (1) corresponds to a numerical expression model relating to a control of the fuel pump 3 including an electric motor 31 used for the model control in accordance with the present invention, in which reference symbol \ddot{θ} in the numerical expression (1) denotes a rotational speed of the fuel pump, reference symbol Uₐ denotes an input voltage in both ends of an armature, reference symbol Rₐ denotes a resistance of the armature, reference symbol Kₑ denotes an induced voltage constant, reference symbol N denotes a gear ratio, reference symbol θ denotes a cam angle, reference symbol \dot{θ} denotes a ω cam angular velocity, reference symbol J denotes an all-inertial moment in a pump crank shaft conversion of a system, reference symbol D denotes a viscous friction coefficient, reference symbol dₖ denotes a Coulomb friction coefficient, reference symbol Kₛ denotes a spring constant of a return spring, reference symbol Kₜ denotes a torque constant, and reference symbol T_{L} denotes a load torque.

The numerical expression (1) mentioned above can be determined as follows. First, considering an electric characteristic of the electric motor corresponding to a drive portion of the control subject, a relation between a current and a voltage in the armature in the armature circuit is expressed by the following numerical expression (2) in accordance with Kirchhoff theory.

$$L \frac{ⅆ {i}_{a}}{ⅆ t} + {R}_{a} {i}_{a} + {K}_{e} N \frac{ⅆ θ}{ⅆ t} = {U}_{a} \qquad ( 2 )$$

In this case, reference symbol iₐ in the numerical expression (2) denotes an armature current, reference symbol Uₐ denotes an input voltage in both ends of the armature, reference symbol L denotes an inductance of the armature, reference symbol Rₐ denotes a resistance of the armature, reference symbol Kₑ denotes an induced voltage constant, reference symbol N denotes a gear ratio, and reference symbol θ denotes a cam angle.

Next, considering a mechanical characteristic of the control subject, if an electromagnetic torque (T) applied to the armature is set to T=NKₜiₐ, a dynamic equation of the fuel pump system finally comes to the following numerical expression (3) in accordance with Newton's law.

$$J \frac{{ⅆ}^{2} θ}{ⅆ {t}^{2}} + D \frac{ⅆ θ}{ⅆ t} + {d}_{k} sign ( \frac{ⅆ θ}{ⅆ t} ) + {K}_{s} θ + {T}_{L} = {NK}_{t} {i}_{a} \qquad ( 3 )$$

In this case, reference symbol iₐ in the numerical expression (3) denotes an armature current, reference symbol N denotes a gear ratio, reference symbol θ denotes a cam angle, reference symbol J denotes an all-inertial moment in accordance with a pump clank shaft conversion, reference symbol D denotes a viscous friction coefficient, reference symbol dₖ denotes a Coulomb friction constant, reference symbol Kₛ denotes a spring constant of a return spring, reference symbol Kₜ denotes a torque constant, and reference symbol T_{L} denotes a load torque.

Further, the numerical expression (1) can be obtained by substituting the numerical expression (2) for the numerical expression (3) on the assumption that the motor current can be controlled with no delay, that is, the inductance component of the armature can be disregarded.

Next, a description will be given of a numerical expression model about a change of an inlet pressure at a time of changing an injection amount used for the model control in accordance with the present invention. The pump volume Vᵣ is calculated in accordance with numerical expression (4) on the basis of a piston cross sectional area Aₘ and a piston stroke hᵣ of the fuel pump 3, and a discharge flow rate Qᵢ of the fuel pump 3 is calculated in accordance with numerical expression (5) on the basis of the pump volume Vᵣ and a cam angular velocity x2.
Vᵣ=Aₘhᵣ (4)
Qᵢ=Vᵣx₂ (5)

Further, on the assumption of setting an input pressure (an injection pressure) of a fuel supply pipe line 6 having a length l from a pump outlet to the injector 8, a cross sectional area S and a volumetric capacity V to P, and setting an output pressure (an atmospheric pressure) thereof to Pₐ, it is possible to determine a change of the inlet pressure P at a tie of changing the injection amount in accordance with the following numerical expression (6).

$$\frac{ⅆ P ( t )}{ⅆ t} = \frac{1}{V ( t ) {K}_{r} ρ ( t )} ( {ρ}_{i} ( t ) {Q}_{i} ( t ) - ρ ( t ) {Q}_{ij} ( t ) - V ( t ) \frac{ⅆ ρ ( t )}{ⅆ t} ) \qquad ( 6 )$$

In this case, reference symbol dP(t)/dt in the numerical expression (6) denotes a pump inlet side discharge pressure with respect to a change of a fuel injection amount, reference symbol Qᵢ(t) denotes a pump discharge flow rate [m³/s], reference symbol Qᵢⱼ(t) denotes an injection amount [m³/s], reference symbol ρᵢ(t) denotes an inflow density (572.467 [kg/m³]), reference symbol p(t) denotes an outflow density [kg/m³], reference symbol V(t) denotes a volumetric capacity [m³], and reference symbol Kᵣ denotes an elastic coefficient [N/m²]

In this case, reference symbols Qᵢⱼ(t) and p(t) in the numerical expression (6) mentioned above are expressed as the following numerical expressions (7) and (8).

$${Q}_{ij} ( t ) = {C}_{n} {A}_{n} \sqrt{\frac{1}{ρ ( t )} 2 g ( P ( t ) - {P}_{a} ( t ) )} \qquad ( 7 )$$

In this case, reference symbol Qᵢⱼ(t) in the numerical expression (7) denotes an injection amount [m³/s], reference symbol ρ(t) denotes an outflow density [kg/m³], reference symbol P(t) denotes a pump discharge pressure [N/m²], reference symbol Pₐ(t) denotes an atmospheric air pressure [N/m²], reference symbol Cₙ denotes an injection flow rate coefficient, and reference symbol Aₙ denotes an injection area [m²].
ρ(t)=kₐP(t)+k_{b} (8)

In this case, reference symbol ρ(t) in the numerical expression (8) denotes an outflow density [kg/m³], reference symbol P(t) denotes a pump discharge pressure [N/m²], and reference symbols kₐ and k_{b} denote a pressure calculation coefficient.

It is possible to easily and accurately determine the base numerical values in the design of the fuel supply apparatus of the engine 1 provided with the fuel supply piping 5, the fuel supply piping 6, the injector 8, the pressure sensor 11, the fuel pump 3 and the electronic control unit 10 which are extended from the fuel tank 2, particularly the fuel supply control program installed in the electronic control unit 10, in accordance with the model base control, by executing a simulation for designing the fuel supply apparatus by using the numerical expressions mentioned above, and it is possible to easily design and manufacture the fuel supply apparatus which can execute an accurate control without actually executing a test. Further, since the model base control method is employed, the control in accordance with the fuel supply control program can easily control the pump rotating speed and the pump discharge flow rate in a wide range while making the pump discharge pressure constant.

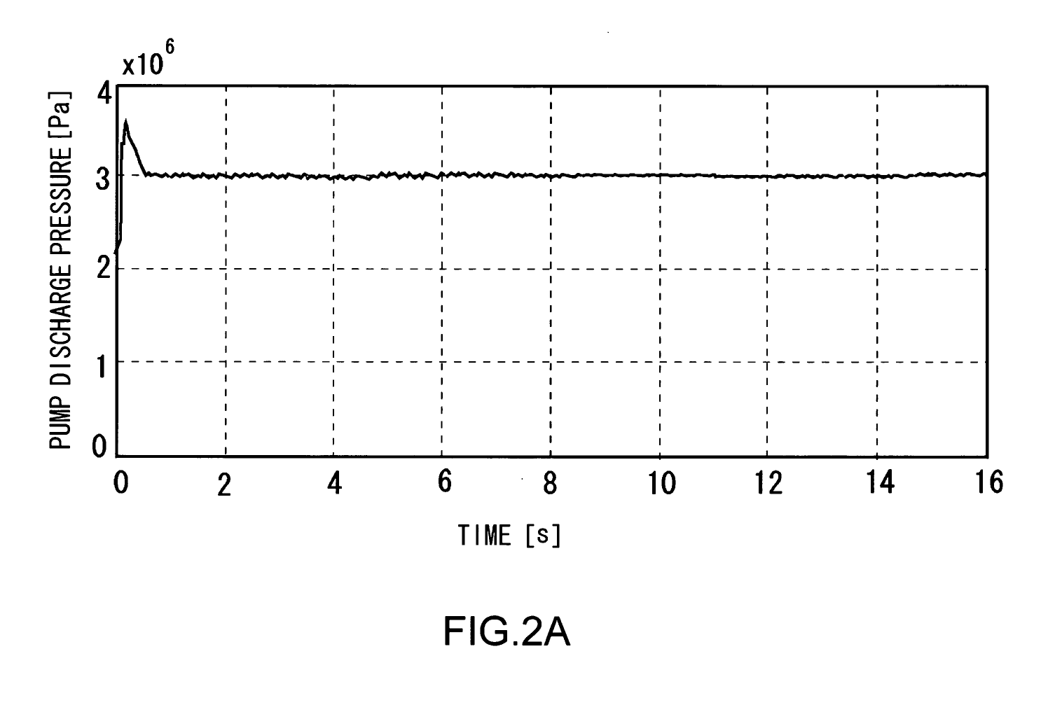

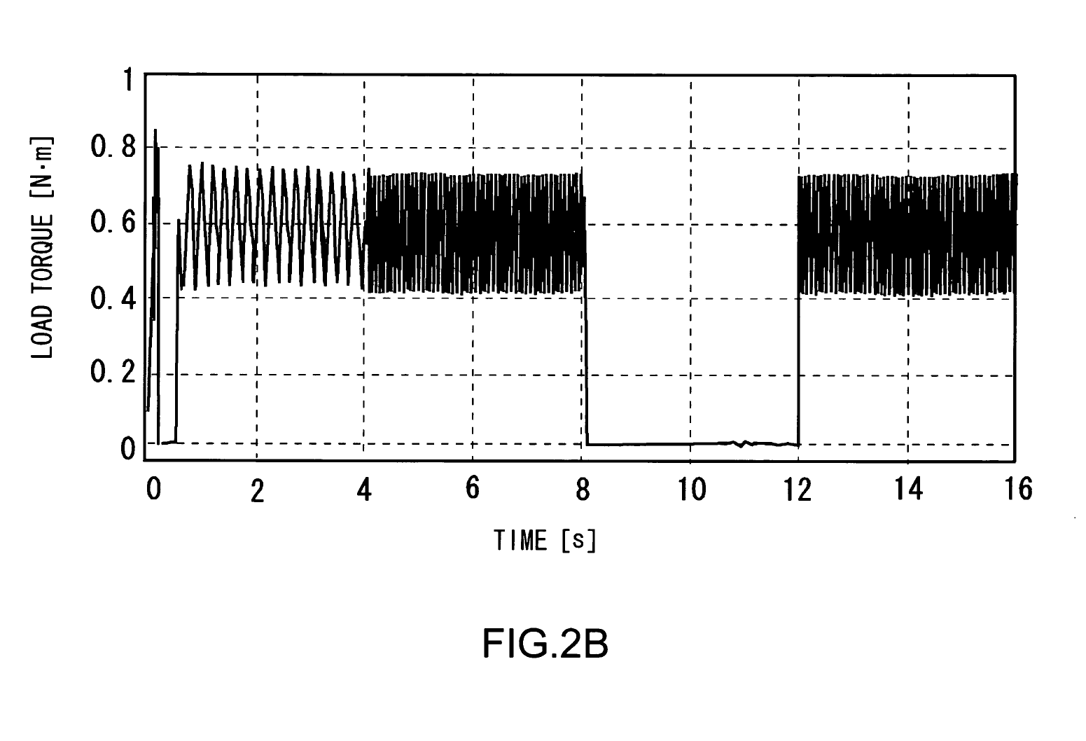

Next, a description will be given of an operation with reference to graphs in FIGS. 2A to 4C showing results of experiments relating to the control by the fuel supply apparatus of the engine in accordance with the present embodiment.

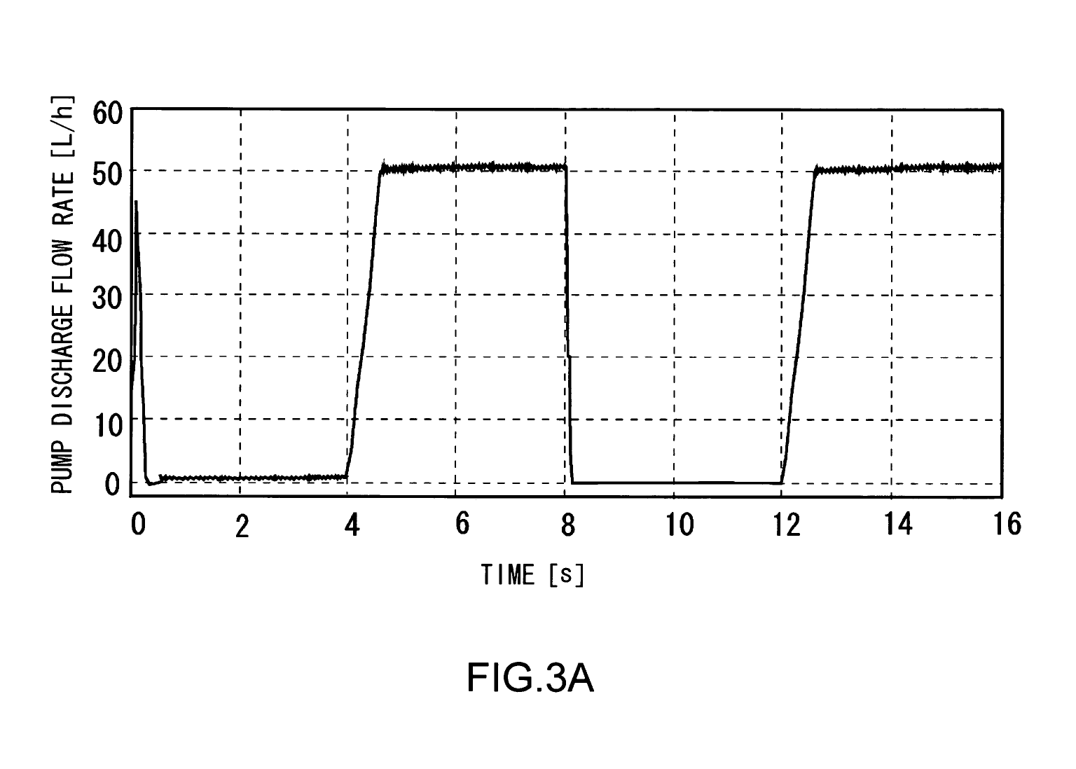

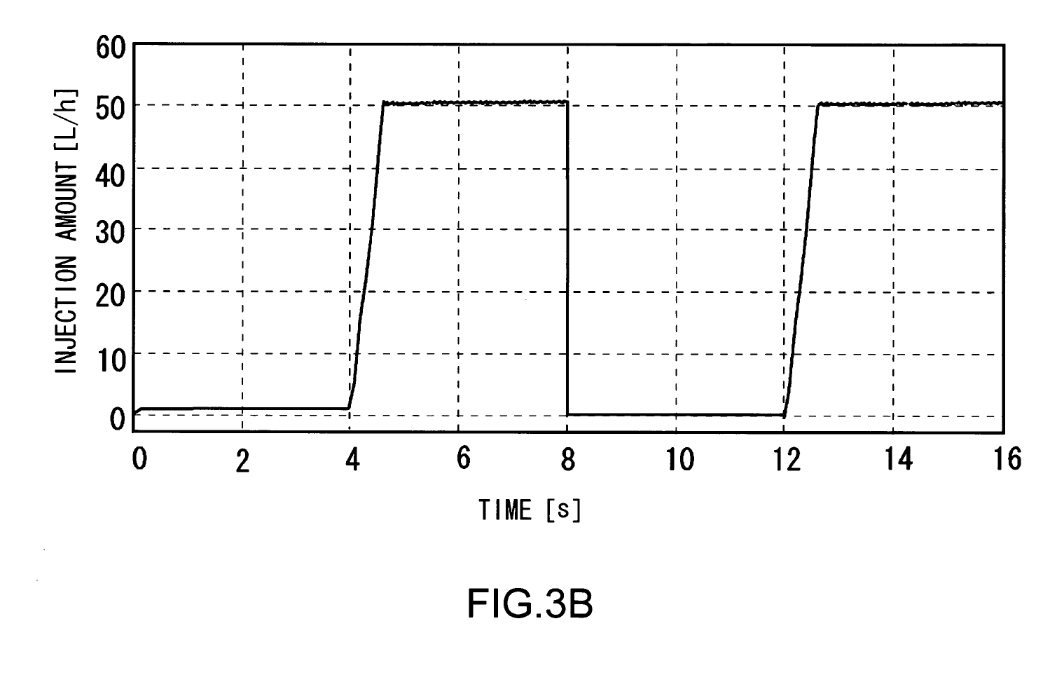

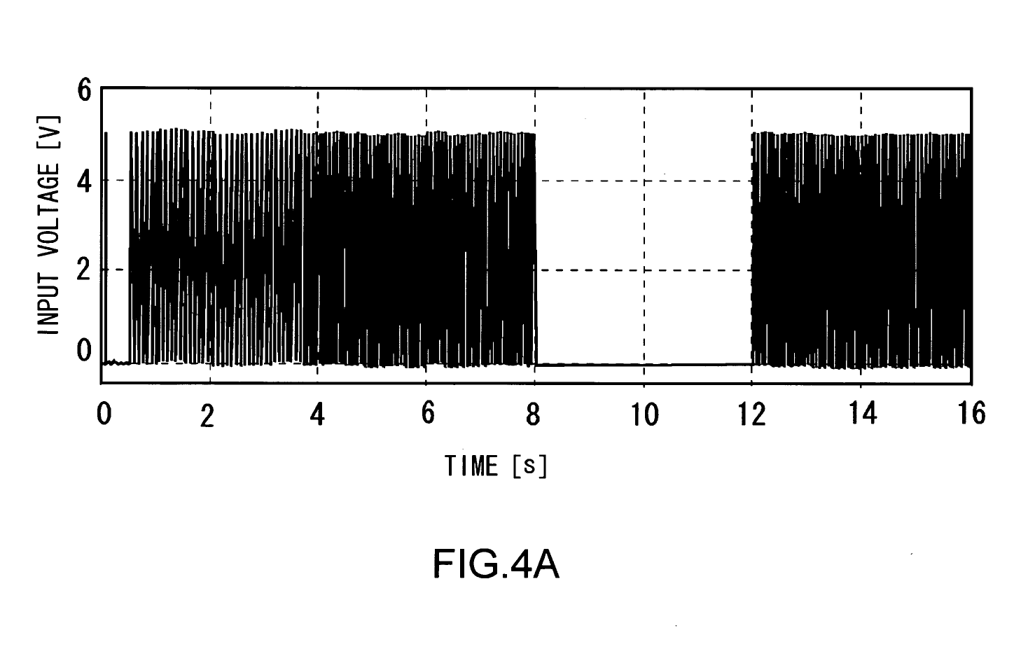

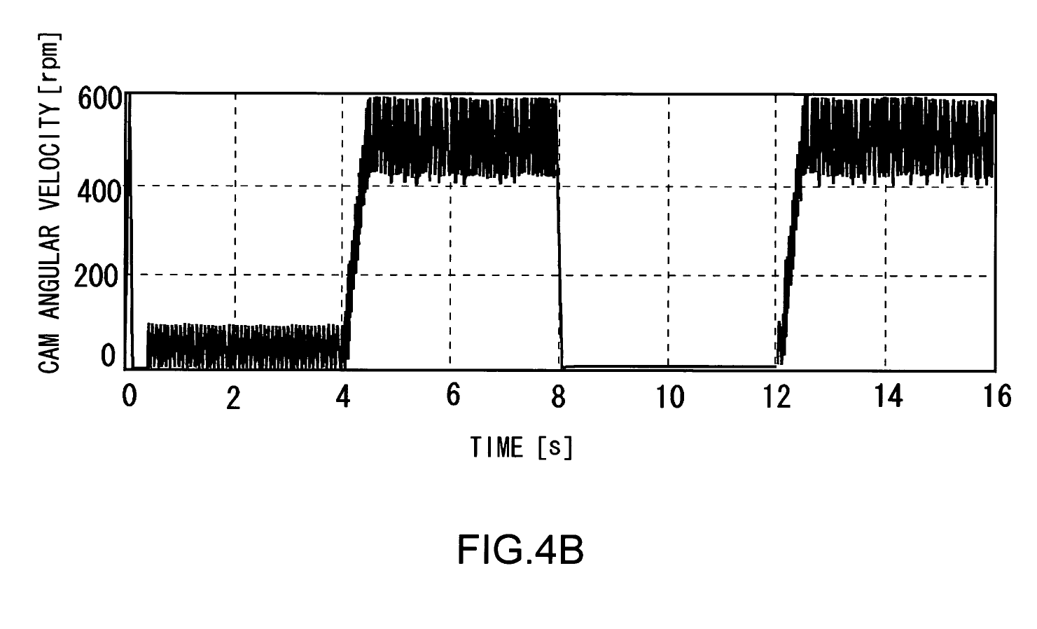

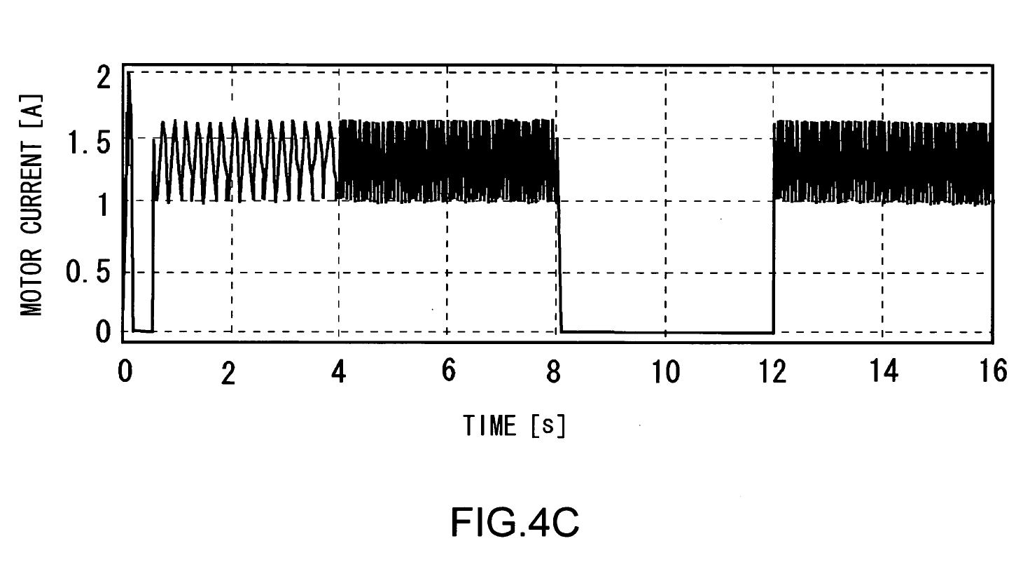

FIG. 2A shows a pump discharge pressure, FIG. 2B shows a load torque, FIG. 3A shows a pump discharge flow rate at this time, and FIG. 3B shows a fuel injection amount from the injector. Further, FIG. 4A shows an input voltage to the electric motor at this time, and FIG. 4B shows a cam angular velocity and FIG. 4C shows a motor armature current. On the basis of these results, it is known that the pump discharge pressure (the fuel injection pressure) is always converged into a fixed target pressure (3 MPa) whatever operating condition of the engine, and the fuel supply control in the fuel supply apparatus of the engine in accordance with the present invention is, effectively operated.

Accordingly, in the conventional liquid fuel supply apparatus of the engine, it is necessary to maintain the extremely great electric power consumption and pump rotational speed by setting the pump driving amount so as to always secure the fuel flow rate equal to or more than the maximum required flow rate, in order to correspond to the maximum required flow rate of the engine. On the contrary, in accordance with the present invention, the pump discharge flow rate is set only such the amount as to maintain at least the fuel pressure in the downstream side of the fuel pump fluctuating in accordance with the fluctuation of the engine rotational speed, and it is possible to secure the minimum input voltage and the minimum electric power consumption as the motor current.

In other words, even if the fuel injection amount is changed, it is possible to control the pump discharge pressure in such a manner that a steady-state error is not generated with respect to a designated target pressure.

Further, the electric current hardly flows through the electric motor 31 in the case that the fuel injection amount is extremely small or during the fuel cut, the fuel pump 3 is operated at the low rotational speed or stopped, and it is possible to restrict the electric power consumption to the minimum. Further, the minimum pump operating amount causes an extension of a service life of the apparatus, thereby tending to achieve an improved fuel supply performance over a long time.

In this case, in the embodiment mentioned above, the description is given of the case that the fuel supply apparatus in accordance with the present invention is applied to the fuel supply system for the gasoline engine, however, it goes without saying that the present invention is not limited to the structure for the gasoline engine, but may be applied to the other fuel supply systems such as a structure employing a fuel more easily vaporized than the gasoline, such as an LPG and a CNG, and the like.

What is claimed is:

1. A fuel supply apparatus of a returnless type engine comprising:
a fuel supply pipe line extended from a fuel tank and having an injector in a leading end side;
an electric motor driven type fuel pump arranged in the fuel supply pipe line;
an electronic control unit in which a fuel supply control program for controlling so as drive the electric motor and the injector is installed; and
a fuel pressurized by the fuel pump being fed to the injector through the fuel supply pipe line so as to be supplied to the engine,
wherein a pressure sensor detecting a fuel pressure so as to output to the electronic control unit is arranged at a predetermined position in a downstream side of the fuel pump of the fuel supply pipe line in which a fuel pressure approximately coincides with a fuel injection pressure, in the fuel supply pipe line, and the electronic control unit continuously calculates a minimum driving amount of the electric motor necessary for maintaining a target fuel injection pressure on the basis of the fuel pressure value continuously detected by the pressure sensor in the electronic control unit so as to command, thereby feedback controlling the operation of the fuel pump and maintaining a fuel injection pressure approximately constant.

2. A fuel supply apparatus of an engine as claimed in claim 1, wherein the fuel supply control program installed in the electronic control unit is designed by utilizing a predetermined numerical expression model relating to the fuel pump control while taking a performance of the electric motor into consideration, and a predetermined numerical expression model taking into consideration a volumetric capacity of the fuel delivery pipe line in the downstream side of the fuel pump for calculating the pump discharge pressure in correspondence to a change of the fuel injection amount, and the fuel supply control by the electronic control unit employs a model base control method.

3. A fuel supply apparatus of an engine as claimed in claim 1, wherein the fuel supply control program installed in the electronic control unit is designed by utilizing the following numerical expression relating to the fuel pump control while taking a performance of the electric motor into consideration, and a predetermined numerical expression model taking into consideration a volumetric capacity of the fuel delivery pipe line in the downstream side of the fuel pump for calculating the pump discharge pressure in correspondence to a change of the fuel injection amount, and the fuel supply control by the electronic control unit employs a model base control method
the numerical expression being expressed by
$$\ddot{θ} = - \frac{1}{J} ( D + \frac{{N}^{2} {K}_{t} {K}_{e}}{{R}_{a}} ) \dot{θ} - \frac{1}{J} {K}_{s} θ + \frac{{NK}_{t}}{{R}_{a} J} {U}_{a} - \frac{1}{J} ( {d}_{k} sign ( \dot{θ} ) + {T}_{L} )$$
in which \ddot{θ} denotes a rotational speed of the fuel pump, Uₐ denotes an input voltage in both ends of an armature, Rₐ denotes a resistance of the armature, Kₑ denotes an induced voltage constant, N denotes a gear ratio, θ denotes a cam angle, \dot{θ} denotes a ω cam angular velocity, J denotes an all-inertial moment in a pump crank shaft conversion of a system, D denotes a viscous friction coefficient, dₖ denotes a Coulomb friction coefficient, Kₛ denotes a spring constant of a return spring, Kₜ denotes a torque constant, and T_{L} denotes a load torque.

4. A fuel supply apparatus of an engine as claimed in claim 1, wherein the fuel supply control program installed in the electronic control unit is designed by utilizing a predetermined numerical expression model relating to the fuel pump control while taking a performance of the electric motor into consideration, and the following numerical expression taking into consideration a volumetric capacity of the fuel delivery pipe line in the downstream side of the fuel pump for calculating the pump discharge pressure in correspondence to a change of the fuel injection amount, and the fuel supply control by the electronic control unit employs a model base control method
the numerical expression being expressed by
$$\frac{ⅆ P ( t )}{ⅆ t} = \frac{1}{V ( t ) {K}_{r} ρ ( t )} ( {ρ}_{i} ( t ) {Q}_{i} ( t ) - ρ ( t ) {Q}_{ij} ( t ) - V ( t ) \frac{ⅆ ρ ( t )}{ⅆ t} )$$
in which dP(t)/dt denotes a pump inlet side discharge pressure with respect to a change of a fuel injection amount, Qᵢ(t) denotes a pump discharge flow rate [m³/s], Qᵢⱼ(t) denotes an injection amount [m³/s], ρᵢ(t) denotes an inflow density (572.467 [kg/m³]), ρ(t) denotes an outflow density [kg/m³], V(t) denotes a volumetric capacity [m³], and Kᵣ denotes an elastic coefficient [N/m²].

5. A fuel supply apparatus of an engine as claimed in claim 1, wherein the fuel supply control program installed in the electronic control unit is designed by utilizing the following numerical expression relating to the fuel pump control while taking a performance of the electric motor into consideration, and the following numerical expression taking into consideration a volumetric capacity of the fuel delivery pipe line in the downstream side of the fuel pump for calculating the pump discharge pressure in correspondence to a change of the fuel injection amount, and the fuel supply control by the electronic control unit employs a model base control method
the numerical expression being expressed by
$$\begin{matrix}\ddot{θ} = - \frac{1}{J} ( D + \frac{{N}^{2} {K}_{t} {K}_{e}}{{R}_{a}} ) \dot{θ} - \frac{1}{J} {K}_{s} θ + \frac{{NK}_{t}}{{R}_{a} J} {U}_{a} - \frac{1}{J} ( {d}_{k} sign ( \dot{θ} ) + {T}_{L} ) \\ \frac{ⅆ P ( t )}{ⅆ t} = \frac{1}{V ( t ) {K}_{r} ρ ( t )} ( {ρ}_{i} ( t ) {Q}_{i} ( t ) - ρ ( t ) {Q}_{ij} ( t ) - V ( t ) \frac{ⅆ ρ ( t )}{ⅆ t} )\end{matrix}$$
in which \ddot{θ} denotes a rotational speed of the fuel pump, Uₐ denotes an input voltage in both ends of an armature, Rₐ denotes a resistance of the armature, Kₑ denotes an induced voltage constant, N denotes a gear ratio, θ denotes a cam angle, \dot{θ} denotes a ω cam angular velocity, J denotes an all-inertial moment in a pump crank shaft conversion of a system, D denotes a viscous friction coefficient, dₖ denotes a Coulomb friction coefficient, Kₛ denotes a spring constant of a return spring, Kₜ denotes a torque constant, T_{L} denotes a load torque, dP(t)/dt denotes a pump inlet side discharge pressure with respect to a change of a fuel injection amount, Qᵢ(t) denotes a pump discharge flow rate [m³/s], Qᵢⱼ(t) denotes an injection amount [m³/s], ρᵢ(t) denotes an inflow density (572.467 [kg/m³]), ρ(t) denotes an outflow density [kg/m³], V(t) denotes a volumetric capacity [m³], and Kᵣ denotes an elastic coefficient [N/m²].
